(19) United States
(12) Patent Application Publication
(10) Pub. No.: US 2008/0005423 A1
(43) Pub. Date: Jan. 3, 2008

(54) Method and device for acting on stylus removal

(76) Inventors: Robert Alan Jacobs, Portland, OR (US); Jim Trethewey, Hillsboro, OR (US)

Correspondence Address: DARBY & DARBY P.C., P.O. BOX 770, Church Street Station, New York, NY, 10008-0770, US

(21) Appl. No.: 11/529,547

(22) Filed: Sep. 29, 2006

Related U.S. Application Data
(63) Continuation-in-part of application No. 11/447,298, filed on Jun. 6, 2006.

(51) Int. Cl. G06F 13/38

(52) U.S. Cl. 710/62

(57) ABSTRACT

An embodiment of the invention relates to a method for acting on removal of a peripheral from a computer, the method containing sensing removal of the peripheral from the computer and promoting the computer to a running state in response to removal of the peripheral. Another embodiment relates to a system configured to promote a computer, the system containing a docking mechanism configured to removably retain a peripheral; and a sensor connected to the docking mechanism and configured to determine when the peripheral is removed from the docking mechanism; wherein, when the sensor determines that the peripheral has been removed from the docking mechanism, the system promotes the computer to a running state.

This application is a continuation-in-part of U.S. patent application Ser. No. 11/447,298, filed Jun. 6, 2006, which is incorporated herein by reference in its entirety.

### BACKGROUND OF THE INVENTION

1. Field of the Invention

The embodiments of the invention relate to a mobile computing device with integrated medical devices such as stethoscopes, blood pressure monitors, vital signs monitors, and other instruments which may be used in a clinical or hospital environment for monitoring the welfare of a patient. Illustrative of computing devices according to the present invention are tablet-style personal computers designed to communicate wirelessly with various medical testing instruments while being convenient to hold and operate and resistant to penetration by fluids.

The embodiments of the invention further relate to the field of automatically triggering computer tasks upon removal of the computer's stylus from a retention mechanism. More specifically, this invention relates to causing a PC to wake upon removal of its stylus from a retention mechanism.

2. Background

A class of personal computers which is smaller than the typical “desktop” or “laptop” devices is known in the art as “tablet” personal computers, or tablet PCs. Such computing devices are generally known for use as personal digital assistants and as specialized, mobile computers. Tablet PC's typically offer the advantage of a small form factor that is easy for the user to carry, but at the cost of limited utility with respect to their full-sized counterparts.

As used herein, the term tablet PC refers to a computer, such as a personal computer, incorporating various convenient and intuitive aspects of pencil and paper into a user's interaction with the computer. Tablet PCs commonly include a stylus. A stylus secretes no ink and is used with a touch screen of the PC. A stylus permits data entry directly into the device via a digitizer, which is positioned behind the display screen to permit data entry by a user. The stylus is typically passive. A suitable stylus device includes the Wacom “Penabled Tablet PC Slim Pen”, model MP200-00 that is 5.5 mm in diameter. The pen can report 256 different levels of pressure when the stylus is pressed against the acrylic LCD protector. The stylus can be sensed at distances between 5 mm and 14 mm away from the digitizer board (this includes the thickness of the LCD panel, air gap, and a protective acrylic cover).

The term “computer” may include at least one central processing unit or CPU (processor) connected to a host bus. The CPU may be any of various types, including an x86 processor, e.g., a Pentium class, a PowerPC processor, a CPU from the SPARC family of RISC processors, as well as others. The computer system may also include various memory mediums, typically including RAM and referred to as main memory. The main memory may store one or more programs implementing the present invention. The main memory may also store operating system software, as well as other software for operation of the computer system.

Tablet PCs provide a very natural way to interact with a computer, namely, by writing on it. Tablet PCs allow for capturing of handwritten notes so that users are able to take notes in their own handwriting, similar to taking handwritten notes with a pen and paper. While providing the simplicity of pen and paper, tablet PCs have the potential to provide many features and benefits provided by word processors and other personal computer software, including sharing of notes among meeting participants in real-time during a meeting via a wireless communication link, for instance. Additional advantages over pen and paper include, but are not limited to, the ability to search notes for particular words, including “fuzzy finds,” and the ability to input information in other ways including speaking and any other suitable means for inputting information.

Among other ways of entering textual information, users will often use the stylus, also referred to as a pen, to write on a display area of the tablet PC. The pen or stylus may also be used as a pointing device directly on the screen or above the screen. Conventional pens or styluses, such as those commonly used with a Personal Digital Assistant (PDA), are removably attached to the tablet PC by being (1) inserted into a deep hole extending into the tablet PC a distance related to the length of the stylus or (2) frictionally retained (e.g., clipped) into a recessed caddy within the PC's chassis, the caddy having a depth related to the width of the stylus. The stylus must be removed from its storage position to interact with the tablet PC.

The retention mechanisms of existing tablet PCs provide no mechanism allowing the tablet PC's operating system to become aware of and/or act upon stylus removal or replacement.

### BRIEF DESCRIPTION OF THE DRAWINGS

The accompanying drawings, which are incorporated herein and form part of the specification, illustrate the present invention and together with the description, further serve to explain the principles of the invention and to enable a person skilled in the pertinent art to make and use the invention. In the drawings, like reference numbers indicate identical or functionally similar elements.

FIG. 1 is a perspective view of an embodiment of a tablet PC capable of acting on stylus removal.

FIG. 2 is a perspective view of another embodiment of a tablet PC capable of acting on stylus removal.

FIG. 3 is an architectural overview of an embodiment of the invention.

### DETAILED DESCRIPTION OF THE INVENTION

As used in the specification and claims, the singular forms “a,” “an,” and “the” include plural references unless the context clearly dictates otherwise. For example, the term “an array” may include a plurality of arrays unless the context clearly dictates otherwise.

In one embodiment, the invention is directed to a method for acting on removal of a peripheral from a computer, the method comprising sensing removal of the peripheral from the computer and promoting the computer to a running state in response to removal of the peripheral.

Preferably, the peripheral is a stylus and the computer is a tablet PC. The method could further include acting on replacement of the peripheral in or on the computer. Preferably, the acting on replacement of the peripheral includes causing the computer to enter one of a hibernation state or a sleep state. Preferably, the acting on removal of the peripheral includes waking the computer from one of a sleep state or a hibernation state. Preferably, the acting on removal of the peripheral further includes starting up an application software. Preferably, the computer is promoted in response to removal of the peripheral. The method could further comprise initiating a peripheral removal event in response to sensing removal of the peripheral from the computer. Preferably, the computer is promoted from one of a hibernation state or a sleep state.

In another embodiment, the invention is directed to a computer system capable of acting on removal of a peripheral. The computer system comprises a docking mechanism for removably retaining the peripheral, and a sensor connected to the docking mechanism and capable of determining when the peripheral is removed from the docking mechanism. When the sensor determines that the peripheral has been removed from the docking mechanism, it promotes the computer to a running state.

Preferably, the sensor is capable of determining when the peripheral is replaced in the docking mechanism. Preferably, when the sensor determines that the peripheral has been replaced in the docking mechanism, it causes the computer to enter one of a hibernation state or a sleep state.

Yet another embodiment relates to a method for promoting a computer containing a sensor configured to determine when the peripheral is removed from the computer, the method comprising delivering a signal from the sensor to a receiver of an embedded controller; generating an interrupt and identification of an event from the embedded controller to facilitate processing a peripheral removal event; raising notification of the peripheral removal event using an advanced configuration and power interface (ACPI) event and associated ACPI control methods; capturing the peripheral removal event with an operating system device driver that includes a device driver for the sensor; translating the peripheral removal event into a human interface device (HID) report that is read by an HID class driver; and sending an input message to application software that has registered an interest in the peripheral removal event.

Yet another embodiment relates to a method for promoting on removal of a stylus from a tablet PC comprising a sensor configured to determine when the stylus is removed from the tablet PC, the method comprising signaling an embedded controller when the stylus is removed from the tablet PC; notifying a system BIOS and device drivers when the embedded controller is signaled that the stylus has been removed; and sending an input message to application software that has registered an interest in the stylus removal.

Preferably, the sensor is located in a stylus retention mechanism. Preferably, the device drivers include an ACPI class driver. Preferably, the device drivers further include an ACPI-to-HID mapper driver. Preferably, the device drivers further include an HID device driver.

Another embodiment relates to a system configured to promote on removal of a peripheral, the system comprising a sensor configured to determine when the peripheral is removed from the computer; an embedded controller having a receiver capable of receiving a signal from the sensor that indicates when the peripheral has been removed from the computer, the embedded controller generating an interrupt and identification of an event that facilitate processing of a peripheral removal event; a system BIOS that raises notification of the peripheral removal event using an ACPI event and associated ACPI control methods; and device drivers that capture the peripheral removal event and translate the peripheral removal event into an input message sent to an application software that has registered an interest in the peripheral removal event.

In yet another embodiment, the invention is directed to a method for acting on removal of a peripheral from a computer, the method comprising sensing removal of the peripheral from the computer, initiating a peripheral removal event in response to sensing removal of the peripheral from the computer, and promoting the computer from a sleep or hibernation state to a running state in response to the peripheral removal event.

Further features of the present invention, as well as the structure of various embodiments of the present invention are described in detail below with reference to the accompanying drawings.

The present invention contemplates a computer, such as a tablet PC, with a peripheral device docking mechanism having a sensor that, when the peripheral device is removed, generates an event that triggers initiation of various programmable tasks, including automatic wake of the system from a “sleep” state. “Sleep” state refers generally to low-power states. Automatic wake is also referred to herein as promoting the computer to a running state. Promotion, as used herein, refers generally to changing a system from a lower powered state to a higher powered state. Demotion, as used herein, refers generally to changing a system from a higher powered state to a lower powered state.

The computer hardware component of a tablet PC typically includes a motherboard with a CPU. The CPU can be, for example, a 478-ball Dothan ULV processor in a micro-FCBGA package and may run nominally at, for example, 1.2 GHz in high frequency mode and at 600 MHz in low frequency mode. The CPU may be socketed or soldered to the motherboard. The system memory can be determined based on the intended application of the tablet PC through the use of commercially-available memory modules, and may include a DRAM module of 1 GB size.

The tablet PC's I/O controller hub (ICH) provides I/O capabilities with suitable known storage device interfaces. The ICH can also provide USB ports for the tablet PC, for devices such as cameras, barcode readers, wireless communication controllers, docking connectors, etc. The ICH further provides a low pin count (LPC) bus that connects to a firmware hub within the tablet PC. The firmware hub is preferably a Flash EPROM storing BIOS code and supporting the use of an embedded controller (EC, also known as a keyboard system controller). Embedded controller refers generally to a programmable microcontroller and may be, for example, a Hitachi H-8 keyboard/system controller. The programmable microcontroller is preferably compliant to the ACPI specification.

An embodiment of the invention provides, within the docking mechanism, a sensor capable of determining when the peripheral device is removed from the docking mechanism. The sensor may be, e.g., a simple mechanical switch, a capacitive sensor, a magnetic switch, or another known suitable sensor. Docking mechanism refers to a mechanism for attaching, docking, or otherwise retaining a peripheral device and can, for example, include a recessed caddy for retaining a stylus.

Upon removal of a peripheral device from the docking mechanism, a signal is created by the sensor and delivered to a receiver. The receiver includes, but is not limited to embedded controller general purpose input/output ports (GPIOs) or interrupt pins. The receiver receives the signal from the sensor for appropriate further processing as set forth below.

A typical embedded controller contains a host interface connecting it to the computer's main CPU, an interface for connection to a scan keyboard, and a number of GPIO pins. The CPU and embedded controller communicate with one another by putting data into the embedded controller's memory and causing an interrupt. The embedded controller's GPIO pins provide a set of I/O ports that can be configured for input or output. In an embodiment of the invention, the GPIO pins are attached to the sensor to sense the state of or “read” the sensor.

The embedded controller includes a memory that reflects a logical state of its GPIO pins. The embedded controller also has a data register and a status/command register that appear in the I/O space of the CPU. The CPU can write to these registers and generate (or raise) an interrupt to the embedded controller signal that something was written to the registers. Similarly, the embedded controller can write content to these registers and generate (or raise) a system control interrupt (“SCI”) to the CPU to signal that something was written to the registers.

In an embodiment of the invention, the embedded controller maps the docking mechanism sensor to a corresponding location in its memory. Data regarding the state of the sensor is then stored in the designated memory location prior to or during the interrupt, so that the CPU can be notified of changes in sensor state (i.e., removal or replacement of a peripheral).

In another embodiment of the invention, the sensor is also able to determine when the peripheral device is replaced in the docking mechanism. The sensor communicates replacement of the peripheral to the CPU as set forth above.

An exemplary embodiment of the invention is described below with reference to the peripheral device being a stylus that is docked in, for example, a recessed caddy of a tablet PC. Upon removal of the stylus from the recessed caddy, the sensor sends a signal to the embedded controller indicating the removal. The embedded controller receives the signal and creates a stylus removal event that is translated to an interface that is used by the system software. Translation involves mapping the stylus removal event as reported by the embedded controller to an HID button code in an HID input report.

The ACPI-to-HID Mapper Driver performs the translation. For example, notification of a stylus removal event can be raised using an advanced configuration and power interface (ACPI) event and associated ACPI control methods in the system BIOS. ACPI also defines an architecture-independent interpretive language called ACPI source language (ASL) that can be compiled into ACPI machine language (AML) and embedded in the system BIOS ROM. The embedded controller provides notification first to the operating system in the form of and SCI interrupt. The operating system determines that the ACPI class driver is responsible for handling the SCI interrupt and transfers control to the ACPI class driver. The ACPI class driver queries the embedded controller to determine which ACPI device type the SCI interrupt applies to, and discovers that it is the AHM device. The ACPI class driver looks to its list of registered client drivers and discovers that the ACPI-to-HID mapper driver is registered to receive AHM events, so the ACPI class driver transfers control to the ACPI-to-HID mapper driver. The ACPI-to-HID mapper driver invokes the ACPI control method(s) in the BIOS to determine that the event was a stylus event, as opposed to some other button event.

The stylus removal event is then captured by an operating system device driver, such as an ACPI-to-HID mapper driver, which generally includes a device driver for the sensor. This ACPI-to-HID mapper driver then translates the stylus removal event into human interface device (HID) keystrokes, preferably according to the USB HID standard. USB HID provides a standardized, flexible, operating system-independent and hardware-independent protocol. The operating system also includes its own hardware-independent device driver (or some other mechanism of reporting GPIO events to the operating system software) that the ACPI-to-HID mapper driver plugs into. The operating systems device driver can be an HID class driver that determines the device associated with the removal event. The HID class driver, therefore, determines that the sensor is associated with the removal event.

In an embodiment of the invention, when the tablet PC is in a sleeping state (e.g., S3 “sleep” or S4 “hibernation” states), the embedded controller designates a stylus removal event as a system “wake” event that promotes the system from its sleeping state to a running state (i.e., a wake state S0). Whether and how the embedded controller designates the stylus removal event as a wake event is determined by the engineer developing the firmware for the embedded controller, who determined which events will be “wake” events. This provides automatic promotion and ease-of-use for end users, such that a stylus removal causes the system to automatically power-up to a ready-to-use state without additional steps of effort by the user. Conversely, the present invention contemplates the system automatically returning to a sleep state upon stylus replacement. Returning the system to a sleep state is accomplished in the same manner described above upon replacing the stylus in the recessed caddy.

As used herein, BIOS refers generally to the software code run by a computer when first powered on. The primary function of the BIOS is to prepare the machine so that other software programs can load, execute, and assume control of the computer. The BIOS can also include a coded program embedded on a chip that recognizes and controls various devices that make up the computer. ACPI is an open industry standard that defines common interfaces for hardware recognition, motherboard and device configuration, and power management. A human interface device (HID) includes any computer device that interacts directly with and takes input from humans (e.g., keyboard, mouse, graphics tablet, etc.). USB (which stands for “universal serial bus”) is a serial bus standard for interfacing devices.

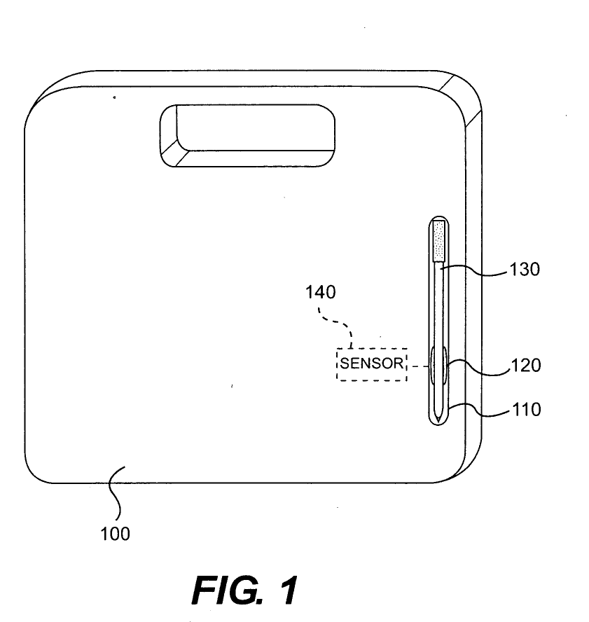

As illustrated in the exemplary embodiment of FIG. 1, a tablet PC capable of acting on stylus removal has a chassis 100 including a stylus retention mechanism that includes a recessed caddy 110 within the PC chassis that includes a retention clip 120. A stylus 130 is removably retained in the recessed caddy 110 by the retention clip 120. The stylus may alternatively be removably retained by other known retention mechanisms. A sensor 140 is provided to sense when the stylus 130 is removed from the retention mechanism. Alternatively the sensor may sense whether or not the stylus is docked. The sensor 140 may additionally sense when the stylus 130 has been replaced in the retention mechanism.

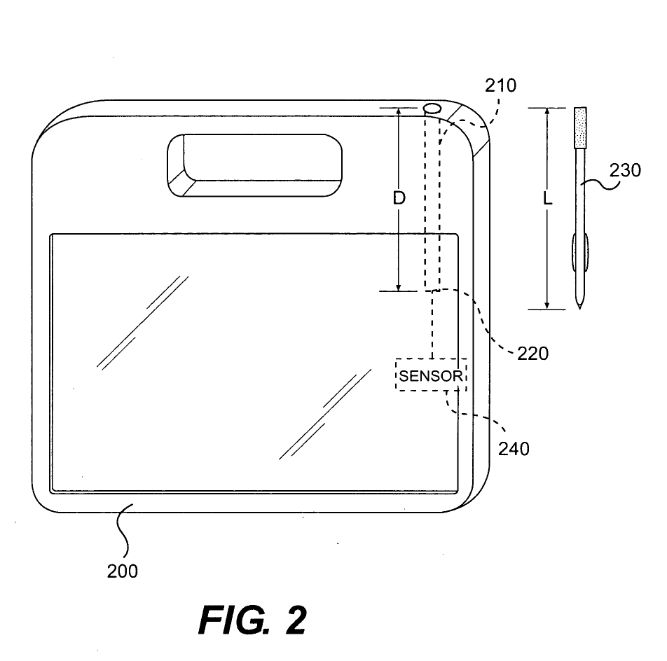

FIG. 2 illustrates another exemplary embodiment of a tablet PC capable of acting on stylus removal. A chassis 200 includes a stylus retention mechanism. In this embodiment, the stylus retention mechanism includes a hole 210 extending into the chassis 200 to a depth D that is comparable to a length L of a stylus 230 to be retained therein. A frictional retention mechanism 220 may be provided within the hole 210 to hold the stylus 230 within the hole when inserted. The stylus 230 is removably retained in the recess 210. The stylus may alternatively be removably retained by other known retention mechanisms. A sensor 240 is provided to sense when the stylus 230 is removed from the retention mechanism. The sensor 240 may additionally sense when the stylus 230 has been replaced in the retention mechanism. As stated above, the sensor may alternatively sense whether or not the stylus is docked. The sensor 240 may be, for example, a mechanical switch, a magnetic switch, or a capacitive switch.

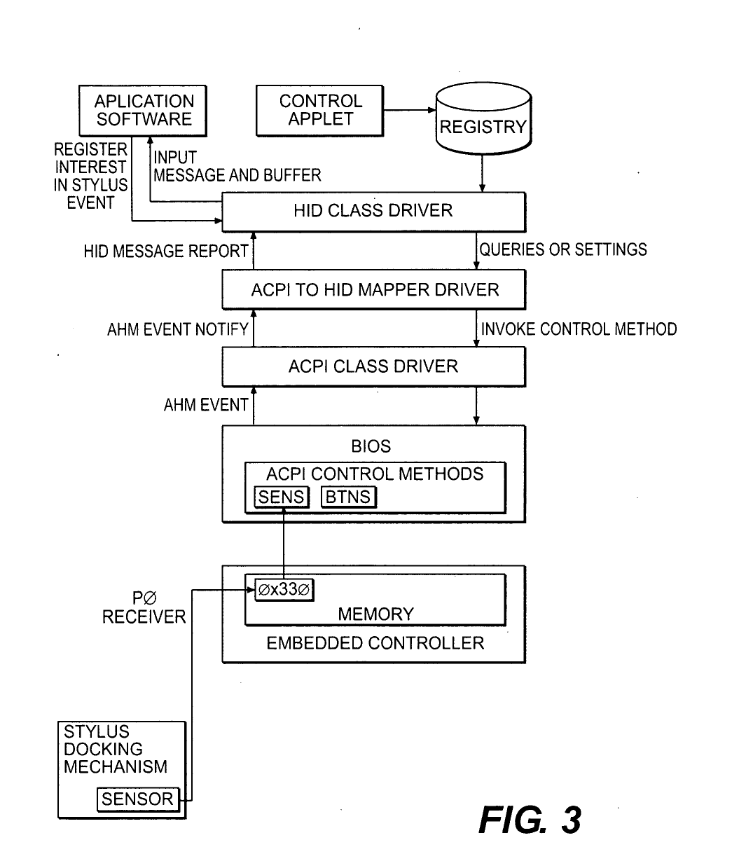

FIG. 3 provides an architectural overview of an embodiment of the invention. As show in FIG. 3, the sensor of the stylus docking mechanism is mapped to a location (byte 0x33.0) in the embedded controller's memory. In the illustrated embodiment, the sensor is on GPIO pin P0. The value of GPIO pin P0 is reflected as bits 0 and 1 in byte 0x33 of the embedded controller's memory. Bit 0 may, for example, represent the stylus being docked. Bit 1 may, for example, represent the stylus being removed. In order to take appropriate actions based on stylus removal or replacement, upon receiving an interrupt from byte 0x33.0 and therefore reading control method SENS to ascertain a status of the docking mechanism sensor, the BIOS generates an ACPI-to-HID mapper driver (AHM) event and “notifies” the ACPI-to-HID mapper driver of the AHM event. SENS is an ACPI control method used to read the status of the sensor in the stylus docking mechanism.

In an embodiment of the invention utilizing Windows, the system includes three device drivers. They include an HID Class Driver, an ACPI-to-HID Mapper Driver, and an ACPI Class Driver. When the system boots, the ACPI-to-HID Mapper Driver loads and registers itself (using the label of “AHM”) with the ACPI Class Driver, so that the ACPI Class Driver will know that when it receives AHM events from the embedded controller, to respond by invoking the ACPI-to-HID Mapper Driver. The ACPI-to-HID Mapper Driver will service stylus (and other) events from the embedded controller. The system designer must assign button numbers to all the buttons/switches on the system. For example, the stylus sensor could be designated as button #4 (the numbers are somewhat arbitrary, but should start at 1 and count up by ones). Stylus events are delivered by the embedded controller as AHM events. In this example, when the ACPI-to-HID Mapper Driver receives notification of an AHM event, it calls BTNS(0) to determine which button/switch caused the AHM event and receives back a “4” to indicate that it was a stylus event.

After determining that a stylus event occurred, the ACPI-to-HID mapper driver reads a table (out of, for example, a Windows registry) describing which HID button codes are associated with button #4. For example, the Windows registry may indicate that button #4 should generate an HID “input report” with {HID page 12, HID usage 1, HID button usage 35} or other similar parameters. The control panel applet allows system administrators to select which HID button code will be assigned to a stylus event. The exact numeric values of the input report are standardized by the USB Implementor's Forum in a specification called the “HID Usage Tables Specification.” The ACPI-to-HID mapper driver then sends an HID report to the operating system's device driver (the HID class driver). It is to be understood that, alternatively, an application programmer can write a program to register with the HID class driver and listen for HID events occurring on a plurality of input reports, and when they occur, identify the HID button.

The interaction between the HID class driver and the application software, according to an embodiment of the invention, is as follows. Application software can “register” its interest in a particular button code, such as the stylus button code, with the HID class driver by using an application programming interface (API) provided by the operating system.

A wake sequence is initiated by the embedded controller. The firmware in the embedded controller is coded to cause the system to wake upon stylus removal. During a wake sequence, when the operating system is resumed from a sleeping state, it will send (broadcast) a “resumed” message to all running applications. When a stylus event occurs, the ACPI-to-HID mapper driver delivers the event to the HID class driver, who delivers it to the application software in the form of an input message, as well as a message buffer indicating that the input type was an HID event, and that it was the stylus button. Using these events, an application will understand that the system has reawakened, and that it was because of a stylus removal. When the stylus is reinserted, another stylus event message will be sent. When any application has been programmed to cause the system to sleep upon stylus insertion, upon receipt of the appropriate HID button code, the system initiates a suspend operation by calling the operation system's suspension API.

To cause the PC to wake or sleep, based on stylus removal or replacement, respectively, the system performs the following process. First, the embedded controller is responsible for PC power management, and is designed to be able to turn the CPU power on and off and direct it to its various wake and sleep states, the most well-known of which are:
“S0”=the CPU is on.
“S3”=the CPU is suspended in sleep mode, which is a low power mode but not completely off. The memory (RAM) is maintained.
“S4”=the CPU is suspended in hibernate mode, where it saves memory (RAM) content to a “hiberfile” and then turns the CPU and memory power completely off.
“S5”=the CPU, memory, and most of the rest of the PC is completely off and will reboot from a reset state rather than using the hiberfile.

According to an embodiment of the invention, the operating system (e.g., Windows) requests that the embedded controller put the CPU in a given mode by writing a sleep type (SLP_TYP) register in the embedded controller's memory (e.g., with a numerical wake or sleep state, such as 0, 3, 4, or 5, as described above). The operating system triggers writing a sleep type register in the embedded controller's memory when the user asks to demote the system's state. In Window's, for example, this is done by going to the Start menu, clicking the “shut down” button, and selecting shut down, restart, standby, or hibernate. Selecting shut down demotes the system to S5 (off). Selecting hibernate demotes the system to S4. Selecting standby demotes the system to S3 (sleep). Selecting restart demotes the system to S5 (off) but then causes the system to reboot.

When the embedded controller sees the request, it performs the required action. Although the embedded controller may turn the CPU and perhaps the entire PC off upon requests, the embedded controller itself may not turn off. The embedded controller continues to run off of available battery power. Firmware in the embedded controller is programmed to understand that the stylus removal should be classified as a wake event and stylus replacement should be classified as a sleep event. When the embedded controller sees a wake event, it turns the CPU on to full power. When the BIOS and operating system start up from a sleep state, they look at the registers in the embedded controller's memory and realize that they are waking from a sleep state and take the correct action. For example:

If waking from S3, memory (RAM) is still current, so the operating system doesn't have to boot anything. If waking from S4, the operating system has to re-load RAM from the hiberfile. If waking from S5, the system has to boot from a reset state. Once the operating system tells the embedded controller that it has awakened from sleep, the embedded controller raises an interrupt to process the stylus removal event as described in the above embodiment of the invention. The stylus removal event is processed by sending an AHM event notification to the ACPI class driver, which calls the ACPI-to-HID mapper driver to translate the stylus button number (e.g., 4) to an HID input report, which is forwarded to the HID class driver and is ultimately delivered to the application programs.

The present invention contemplates the user being able to enable or disable the PC's ability to wake up stylus removal or to sleep upon stylus replacement. The present invention also contemplates other actions causing the system to wake and sleep, such as plugging in or turning on a peripheral such as a keyboard, mouse, or recording device. For medical applications, the peripheral may include such devices as, for example, a wireless blood pressure gauge, a thermometer, or a wireless stethoscope. Other peripheral devices and features that might be incorporated into the platform include, but are not limited to, digital cameras, RFID readers, bar code readers, Bluetooth connectivity, audio I/O, a docking station which may include warm-swappable batteries.

What is claimed is:

1. A method for promoting a computer, the method comprising removing a peripheral from the computer, sensing removal of the peripheral from the computer, and promoting the computer to a running state.

2. The method of claim 1, wherein the peripheral is a stylus and the computer is a tablet PC.

3. The method of claim 1, wherein the method further includes acting on replacement of the peripheral in or on the Computer.

4. The method of claim 3, wherein acting on replacement of the peripheral includes causing the computer to enter one of a hibernation state or a sleep state.

5. The method of claim 1, wherein acting on removal of the peripheral includes waking the computer from one of a hibernation state or a sleep state.

6. The method of claim 1, wherein acting on removal of the peripheral further includes starting up an application software.

7. The method of claim 1, wherein the computer is promoted in response to removal of the peripheral.

8. The method of claim 1, further comprising initiating a peripheral removal event in response to sensing removal of the peripheral from the computer.

9. The method of claim 8, wherein the computer is promoted from one of a hibernation state or a sleep state.

10. A system configured to promote a computer, the system comprising:
a docking mechanism configured to removably retain a peripheral; and
a sensor connected to the docking mechanism and configured to determine when the peripheral is removed from the docking mechanism;
wherein, when the sensor determines that the peripheral has been removed from the docking mechanism, the system promotes the computer to a running state.

11. The computer system of claim 10, wherein the peripheral is a stylus and the computer is a tablet PC.

12. The computer system of claim 10, wherein the sensor is capable of determining when the peripheral is replaced in the docking mechanism.

13. The computer system of claim 12, wherein when the sensor determines that the peripheral has been replaced in the docking mechanism, it causes the computer to enter one of a hibernation state or a sleep state.

14. The computer system of claim 10, wherein acting on removal of the peripheral includes waking the computer from one of hibernation state or a sleep state.

15. The computer system of claim 10, wherein acting on removal of the peripheral includes starting up an application software.

16. A method for promoting a computer confirming a sensor configured to determine when the peripheral is removed from the computer, the method comprising:
delivering a signal from the sensor to a receiver of an embedded controller;
generating an interrupt and identification of an event from the embedded controller to facilitate processing a peripheral removal event;
raising notification of the peripheral removal event using an ACPI event and associated ACPI control methods;
capturing the peripheral removal event with an operating system device driver that includes a device driver for the sensor;
translating the peripheral removal event into an HID report that is read by an HID class driver; and
sending an input message to application software that has registered an interest in the peripheral removal event.

17. The method of claim 16, wherein the peripheral is a stylus and the computer is a tablet PC.

18. The method of claim 16, wherein the method further includes acting on replacement of the peripheral in or on the computer.

19. The method of claim 18, wherein acting on replacement of the peripheral includes causing the computer to enter one of a hibernation state or a sleep state.

20. The method of claim 16, wherein acting on removal of the peripheral includes waking the computer from one of a hibernation state or a sleep state.

21. The method of claim 20, wherein acting on removal of the peripheral further includes starting up an application software.

22. A method for promoting on removal of a stylus from a table PC comprising a sensor configured to determine when the stylus is removed from the tablet PC, the method comprising:
signaling an embedded controller when the stylus is removed from the tablet PC;
notifying a system BIOS and device drivers when the embedded controller is signaled that the stylus has been removed; and
sending an input message to application software that has registered an interest in the stylus removal.

23. The method of claim 22, wherein the sensor is located in a stylus retention mechanism.

24. The method of claim 22, wherein the device drivers include an ACPI class driver.

25. The method of claim 24, wherein the device drivers further include an ACPI-to-HID mapper driver.

26. The method of claim 25, wherein the device drivers further include an HID device driver.

27. The method of claim 26, wherein acting on removal of the peripheral further includes starting up an application software.

28. The method of claim 22, wherein acting on removal of the peripheral includes waking the computer from a sleep state.

29. The method of claim 22, wherein acting on removal of the peripheral includes waking the computer from a hibernation state.

30. A system configured to promote on removal of a peripheral, the system comprising:
a sensor configured to determine when the peripheral is removed from the computer;
an embedded controller having a receiver capable of receiving a signal from the sensor that indicates when the peripheral has been removed from the computer, the embedded controller generating an interrupt and identification of an event that facilitate processing of a peripheral removal event;
a system BIOS that raises notification of the peripheral removal event using an ACPI event and associated ACPI control methods; and
device drivers that capture the peripheral removal event and translate the peripheral removal event into an input message sent to an application software that has registered an interest in the peripheral removal event.

31. The computer system of claim 30, wherein the peripheral is a stylus and the computer is a tablet PC.

32. The computer system of claim 30, wherein the method includes acting on replacement of the peripheral in or on the computer.

33. The computer system of claim 30, wherein acting on replacement of the peripheral includes putting the computer into a hibernate state or a sleep state.

34. The computer system of claim 30, wherein acting on removal of the peripheral includes waking the computer from a hibernate state or a sleep state.

35. The computer system of claim 30, wherein acting on removal of the peripheral further includes starting up an application software.
